(19) United States
(12) Patent Application Publication
(10) Pub. No.: US 2020/0098016 A1
(43) Pub. Date: Mar. 26, 2020

(54) SYSTEM AND METHOD FOR SAVING, RETRIEVING, ANALYZING, AND REPORTING ON ELECTRONIC AND PAPER TRANSACTION RECORDS

(71) Applicant: UST Global (Singapore) Pte. Ltd., Singapore (SG)

(72) Inventors: Jerin Jacob, Trivandrum (IN); Jijumon Kallikattu Gopi, Trivandrum (IN); Suji Kumar Thankarajan Sarasamma, Trivandrum (IN)

(21) Appl. No.: 16/583,689

(22) Filed: Sep. 26, 2019

(30) Foreign Application Priority Data
Sep. 26, 2018 (IN) 201811036238

(51) Int. Cl. G06Q 30/02; G06Q 20/20; G06Q 20/04

(52) U.S. Cl. CPC G06Q 30/0276; G06Q 30/0255; G06Q 20/0453; G06Q 20/202

(57) ABSTRACT

A system and method to record a receipt of a transaction is disclosed. A point of sale device at a seller location accepts a sales data input indicating a purchase by a customer. A transceiver is coupled to the point of sale terminal. The transceiver transmits the sales input data. A transaction server is configured to receive the sales input data. The transaction server generating a receipt of a sale based on the sales input data. A mobile device is accessed by the transaction server. The transaction server sends the receipt to the mobile device for storage.

### PRIORITY CLAIM

This application claims priority to Indian Provisional Application No. 201811036238, filed Sep. 26, 2018. That application in its entirety is hereby incorporated by reference.

### TECHNICAL FIELD

The present disclosure relates generally to a system to store transactions, and more specifically, to a method and system to provide storage on user devices of transaction receipts.

### BACKGROUND

Consumer purchases made in “brick-and-mortar” stores as well as online outlets (e.g., Amazon, etc.) result in an overabundance of paper and electronic transaction receipts that are necessarily kept separately. Management of electronic and paper receipts is therefore a challenge of retention and organization with misplacement and loss of records common.

Because electronic and paper transaction receipts are held in disparate locations (that is, they are of differing formats and cannot be stored together) creating trend reports, tax-related reports, or analyzing purchasing patterns for the retailer or the customer is difficult if not impossible. When receipts are lost transaction information may be unrecoverable, and return or exchange of purchased items may be hindered or prevented.

Thus, there is a need for a system that provides buyers electronic receipts of their transactions. There is a further need for a system that provides an interface to merchant users to determine records of transactions. There is a need for a system that allows data to be analyzed and for merchant users to leverage the analysis to create promotions for customers.

### BRIEF DESCRIPTION OF THE DRAWINGS

The disclosure will be better understood from the following description of exemplary embodiments together with reference to the accompanying drawings, in which:

FIG. 1 is a block diagram of an example transaction system between different customers and different merchants to allow recording of sales receipts;

FIG. 2 is a detailed block diagram of the transaction server of the example transaction system in FIG. 1;

FIG. 3 is a screen image of a merchant dashboard interface generated by the transaction system in FIG. 1;

FIG. 4 is a screen image of an interface to allow the merchant to set up a tailored promotion using the transaction system in FIG. 1;

FIG. 5 is a flow diagram of the process of setting up a promotion; and

FIG. 6A-6C are images of customer user interfaces on a mobile device generated from the mobile application of the transaction system in FIG. 1.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

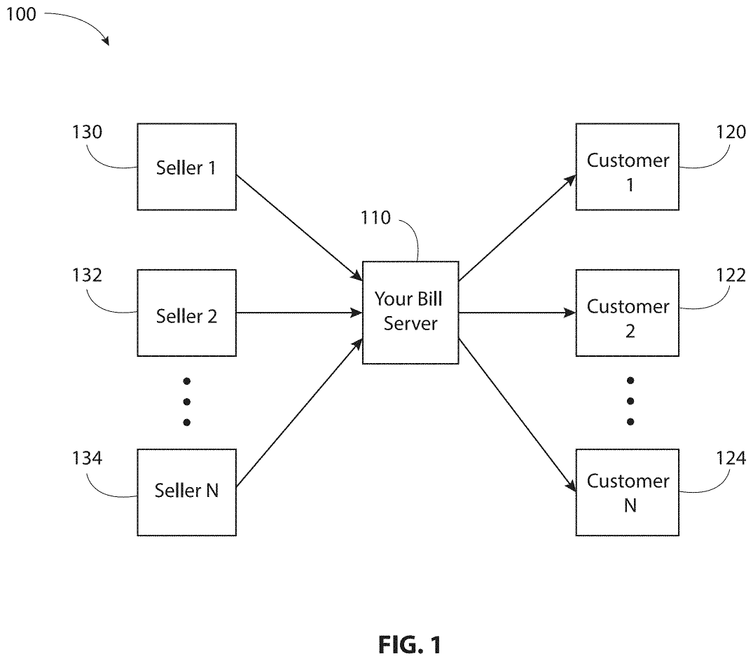

FIG. 1 is a block diagram of an example transaction system 100 between merchants/sellers and customers that allows tracking of transactions by receipts. The system 100 includes a transaction server 110 that is coupled to a series of customer devices 120, 122 and 124. The customer devices 120, 122, and 124 may be mobile devices such as smart phones. Each of the customer devices 120, 122 and 124 has a transaction application that communicates with the transaction server 110 and allows the storage of receipts for the convenience of the customer. A series of merchants each have a point of sale devices such as point of sale devices 130, 132, and 134. The various devices shown in FIG. 1 may communicate via a network, which may either be hardwired and accessed via network interface cards on the devices and or wirelessly via a transceiver on each of the devices.

During every transaction at a store, the bill is posted at the application executing on the device of a respective customer. On every transaction, the point of sale devices 130, 132 or 134 pushes bill data to the transaction server 110. The customers may use smartphone application to view their transactions. The transaction server 110 will process the transactions and pushes the transaction record to the customer user devices 120, 122, and 124. Notification of the transactions is also provided to the customers via the application on the user devices 120, 122, and 124. Each seller can access their profile at the transaction server 110 through a dashboard interface. As will be explained below, the dashboard interface displays summaries of each transaction conducted with the seller and provides other analytical functions.

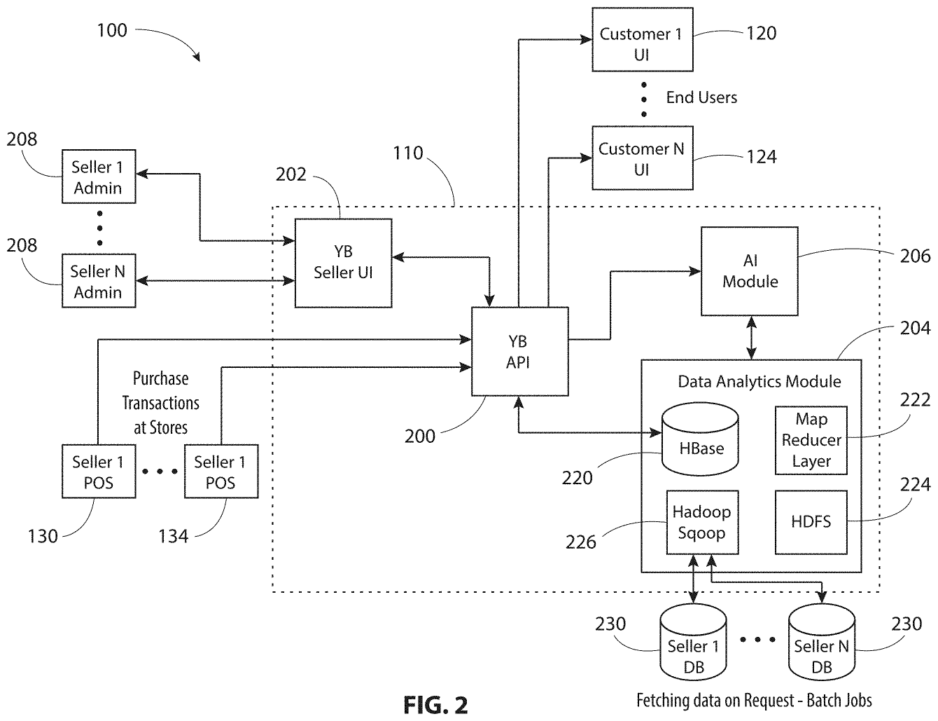

FIG. 2 is a block diagram of the specific components of the transaction server 110 and other elements of the system 100 in FIG. 1. The transaction server 110 includes a transaction application program interface (API) module 200, a seller user interface module 202, a data analytics module 204, and an artificial intelligence module 206. Seller administrative devices 208 for each seller are coupled to the seller user interface module 202. The seller user interface module 202 generates interface displays such as a dashboard on the seller administrative device 208. The point of sale devices 130, 132, and 134 are also coupled to the API module 200. The data analytics module 204 includes a database 220, a map reducer layer 222, a distributed file system 224, and a transfer tool 226. Each of the sellers has an associated seller database 230 that is accessible by the data analytics module 204. The seller database 230 includes individual sales data transmitted from the point of sale devices 130, 132, and 134 belonging to the individual sellers.

The seller POS (Point of Sale) devices such as the POS devices 130 and 134 each may generate the bill/invoice details when a transaction is made between the seller and a customer. The POS devices push the transaction details to the API module 200 of the transaction server 110. These details include information such as the amount of money spent, the product, the price, and the time. The seller administration devices 208 provide a profile for handling all the activities of the respective seller. The profile is accessed through an interface generated on the seller administration devices 208 by the seller user interface module 202.

In this example, the seller user interface module 202 generates a seller dashboard (or seller user interface) on the seller administration devices 208 to access the profile and to perform all the interaction with the transaction sever 110. The Application Program Interface (API) module 200 is a central part of the architecture of the transaction system 100. The API module 200 acts as an interface to obtain the data from seller point of sale devices such as the POS device 130. The API module 200 also analyzes information and sends the information to the main database 220. The data analytics module 204 analyzes the data from the sellers and the customers in the main database 220. As will be explained below, the data analytics module 204 may access customer and sales data to assist sellers in promotions and other functions. In addition, the operators of the transaction system 100 may also use the data analytics module 204 for functions such as registering additional sellers or customers.

The transaction system 100 relies on analysis of big data, requiring a distributed computing environment. In this example, an open source, Java-based programming framework that supports the processing and storage of extremely large data sets in a distributed computing environment, such as Hadoop, and uses a distributed file system for storing big data. In this example, a parallel, distributed algorithm on a cluster application, such as MapReduce, is used to process the data. In this example, Hadoop excels in storing and processing of huge data of various formats such as arbitrary, semi-, or even unstructured formats.

The database 220 stores structured data for the transaction server 110. For example, structured data may include transaction data (receipt data), customer data and other required formatted data. The map reducer layer 222 is used for analytics. The map reducer layer 222 interacts with the AI module 206 for analysis based on the data in the main database 200.

The distributed file system 224, which is a HDFS (Hadoop Distributed File System) in this example, is used to fetch and handle huge volume of data. The distributed file system 224 is used to get data needed for batch jobs requested on behalf of a seller request. As will be explained below, batch jobs may be performed for populating customers for a promotion. The HDFS distributed file system 224 is also used for analysis purposes. A transfer tool 226 such as the Hadoop Sqoop protocol is the mechanism used for this purpose to get data from the seller databases 230.

In reference to FIGS. 1-2, when a purchase occurs, the transaction data (e.g., cost, item, date, time, location, etc.) is added to the seller's database 230 based on the registered customer's ID. The customer ID and transaction data is transmitted during the purchase transaction from the consumer device such as the devices 120, 122, and 124 in FIG. 1. At the same time, transaction data is also transferred from the seller's POS device, such as the device 130, to the transaction API 200 of the transaction server 110. The transaction data will be mapped to the main database 222. The main database 222 is the data storage for the transaction data of each person.

When a purchase occurs, the transaction data from the seller is transferred (or made available via request, depending on system configurations) from the seller's database 230 to the transaction system 100 for processing and later retrieval/use. Transaction data (e.g., cost, item, date, time, location, etc.) from in person and online purchases are saved in an account associated with a customer user for easy retrieval and later reference. When purchasing from a seller not affiliated with the application, the customer user may scan the receipt into the application with a camera on their smart phone or mobile device. The application on the user device converts the scanned receipt to a readable template that is then available in the mobile device application. Once the receipt is scanned and uploaded, the algorithm determines the transaction type (medical, fuel etc.), date of transaction, and amount. The customer user is (or can be) prompted when the process is complete. The user can then make any edits, if required, and then save the receipt in the mobile devices.

Merchants or sellers who desire to take advantage of the transaction system 100 must be registered. The merchant registration process involves a series of agreements and documentation. A high-level description of the process is as follows. Initially, a merchant must come to an agreement with the operator of the transaction system 100, which mainly focuses on data sharing, security and other important verifications. Once agreement is complete, the administrator of the transaction system 100 performs the approval and creates a mail account on behalf of the system 100 e.g. (seller_name@yourbill.org). The transaction system mail ID credentials are shared to the seller/merchant's personal email account. Sellers may then login with their credentials at the transaction system mail and reset for a new password. In this example, this mail ID is used for all formal communication between merchant and the operators of the transaction system 100. Initially the merchant will receive a welcome letter, followed by a merchant dashboard generated on the administrative device of the seller and login credentials. In this example, the merchant may be provided a different set of login ID and password for access to the dashboard interface.

Each customer also follows a registration process. Customer user requirements are that each customer must have a smart phone or similar mobile device and a mobile telephone number. The customer must register with a seller that has an account with the transaction system 100. For example, every customer who purchases from an enrolled seller/retailer for the first time will be requested to do a onetime registration using their mobile number. The transaction system 100 uses the information gathered in this process to add the customer to the transaction system 100. Therefore, these is no separate user registration requirement in such situations where the customer makes a purchase through a registered seller.

Once registered, the customer must download, install, and register the application on their mobile device. There may be two scenarios for the customer registration. First, the customer may have already purchased goods or services from a registered seller but not installed the application. When the customer purchases goods or services from a registered seller, the customer will provide a mobile number to receive the receipt. The customer billing data will thus be available to the transaction system 100. A customer account is then created in the transaction system 100 based on the registered mobile number used at the store/seller. The link to the application will be sent to the mobile device of the customer. On receiving the link, the customer may install the mobile application to access their receipt electronically. The installed application runs a registration routine and assigns the customer a log in PIN. The customer may then access and update their personal profile through an interface generated by the now installed application on the mobile device.

The second scenario is where the customer has not purchased anything from a registered seller but has installed the application on the mobile device. In this case, the customer installs the application prior to making purchases. When the customer makes a purchase from a registered merchant, the bill data will be updated in the account associated with the merchant. The customer will provide a mobile number at the purchase point and thus data may be exchanged between accounts.

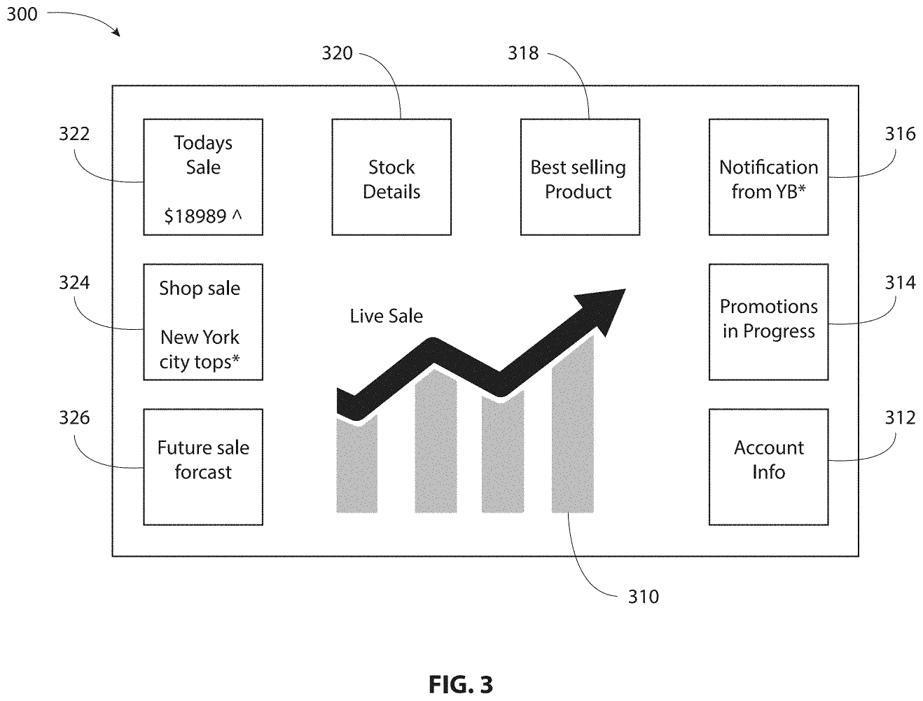

FIG. 3 is a screen image of a dashboard interface 300 generated by the seller user interface module 202 in FIG. 2. The example merchant dashboard interface 300 is the admin web portal for a merchant registered with the transaction system 100 and may be generated on a seller administration device. The dashboard interface 300 allows a merchant to login and monitor their sales and other important information.

The dashboard 300 includes a sales graphic 310, an account information field 312, a promotions in progress field 314, a notifications field 316, a best selling product field 318, a stock details field 320, today sale field 322, a shop sale field 324, and a future sale forecast field 326. The different fields displayed on the dashboard 300 allow a seller to monitors their business with transaction system 100.

The seller graphic 310 represents live sale details including daily/weekly/monthly transactions. The stock details field 320 provides details on stock of products at the seller. The bestselling products field 318 displays products and the respective product selling rate. The highest or lowest or any such criteria can be sorted in this field.

The transaction system notifications field 316 displays push messages from the transaction system 100. For example, possible promotion suggestions which can be generated and provided to customers will be listed and notified to the seller. This space is also used for any urgent/important notice to the seller from the transaction system 100. The shop sale field 324 displays the top selling store of this seller. The future sales forecast field 326 displays trends in the market and analysis done through artificial algorithms. The account information field 312 displays seller account specific information.

Another feature offered by the transaction system 100 is initiation of promotions by the seller to customers. The promotions field in progress field 314 allows a seller to generate Voucher/Promotion coupons to the customers based on different criteria. The criteria can be made on any factor selected by the seller user. The seller user may thus select and refine promotions with the assistance of the transaction system 100. Proprietary algorithms are used to match users with merchant promotions. Natural language processing and machine learning in conjunction with the data collected by the transaction system 100 may be used to find the right promotion requested by seller.

For example, the seller navigates to the promotions field 314 from the dashboard 300. In this area, the seller is provided with a search area which is used to find the right set of customers eligible for the any kind of promotions. The AI module 206 will be executed to find a suitable result in response to the query. The AI module 206 will analyze under ‘Natural Language Processing’ along with ‘Machine Learning’ and summarize the requirement.

Natural language processing (NLP) APIs are generally available. In this example, limited natural language processing is used for the promotion initiation feature. For instant analysis of the query from the user (retailer), a stripped-down version of the English language is supported to create direct instructions. In this example, four Natural Language Processing (NLP) libraries are compatible with the invention. The four NLP libraries include the Natural language toolkit (NLTK), the Apache OpenNLP, the Stanford NLP suite, and the Gate NLP library. In this example, the Natural Language tool kit (NLTK) is the preferred library platform for the system. In this example, Python is the programming language used. For exception situations where the AI module 206 does not produce a suitable result, the system will include human support for the user at any time. Thus, if the seller is not happy with the result, then the seller can directly reach out to a support team of the operator for assistance in formulating the query.

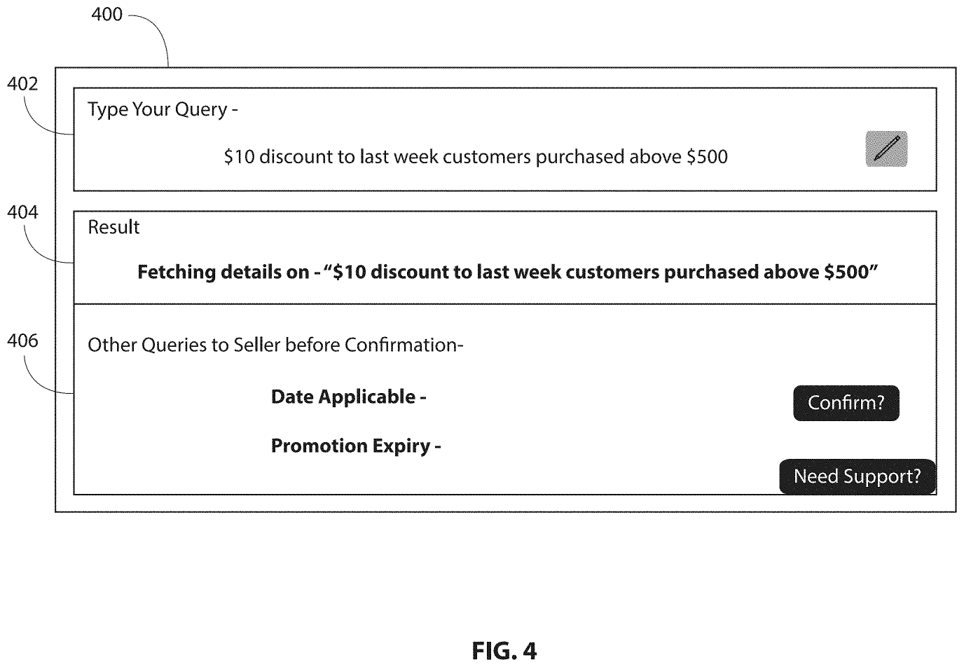

FIG. 4 shows a promotional interface 400 that is displayed to a seller from the promotions field 314 of the dashboard 300. The interface 400 includes a query input field 402, a result field 404 and a queries to seller field 406. The query input field 402 allows the seller to provide a natural language query for a proposed promotion. The result field 404 will provide details in response to the query. The queries to seller field 406 will provide the seller additional options such as the applicable date and expiration date of the proposed promotion.

For example, if a seller is planning to give away $10 discount to customers who purchased above $500 of products in the previous week, the seller first navigates to the promotion tab 314 and an interface such as the interface 400 is displayed. The seller then types the criteria for the promotion in the query input field 402. The seller can type the criteria in natural language (e.g., English) and while typing, the AI module 206 will be providing suggestions. For example, the seller may type “$10 discount to last week customers purchased above $500” or a similar query. The result will be generated with a summary. If the seller is happy with the result, they can select the approve option in the queries to seller field 406 to roll out the promotion. Otherwise, support team help can be requested or the seller may refine the requested promotion criteria. If support team help is requested, the transaction system 100 may provide an on-line dialog window or provide contact information to speak with a support specialist directly.

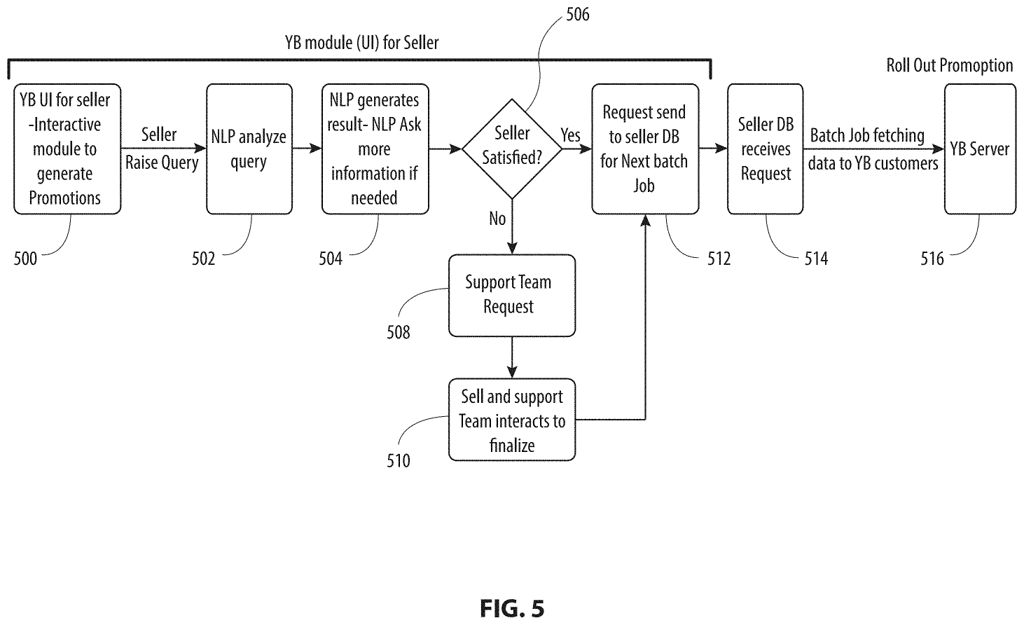

FIG. 5 is a flow diagram of the process of creating promotions. The seller user interface such as the interface 400 in FIG. 4 is provided for a seller to generate promotions (500). The natural language processing algorithm analyzes the received query (502). The transaction server 110 will generate the search result and request additional information if needed through the queries through seller field 406 in FIG. 4 (504). The field 406 also displays a confirm button that allows a seller to indicate they are satisfied with the proposed promotion request (506). If the seller is not satisfied, the seller may request support from the support team (508). Additional operators may then provide manual assistance to finalize the promotion request (510).

Once the promotion request is successfully raised by the seller either automatically or via assistance, the request will then get processed at the transaction server 110 and a batch Job will be run to fetch the data through the Hadoop Sqoop transfer tool 226 (512). The transfer tool 226 will send the request to the seller database 230 (514). The batch job will then be executed to provide the seller data and customer data for the promotion roll out (516). Finally, the transaction server 110 will keep the data in the database 222 and map it to respective customer coupon carts generated by the mobile device application as will be explained below.

The customers that are registered with the transaction system 100 may be notified of new transaction data availability via the application on their user device. Such transaction data may be the receipts for purchases made from registered sellers. Optionally, such notification may take place via SMS notification to a registered mobile number of the customer.

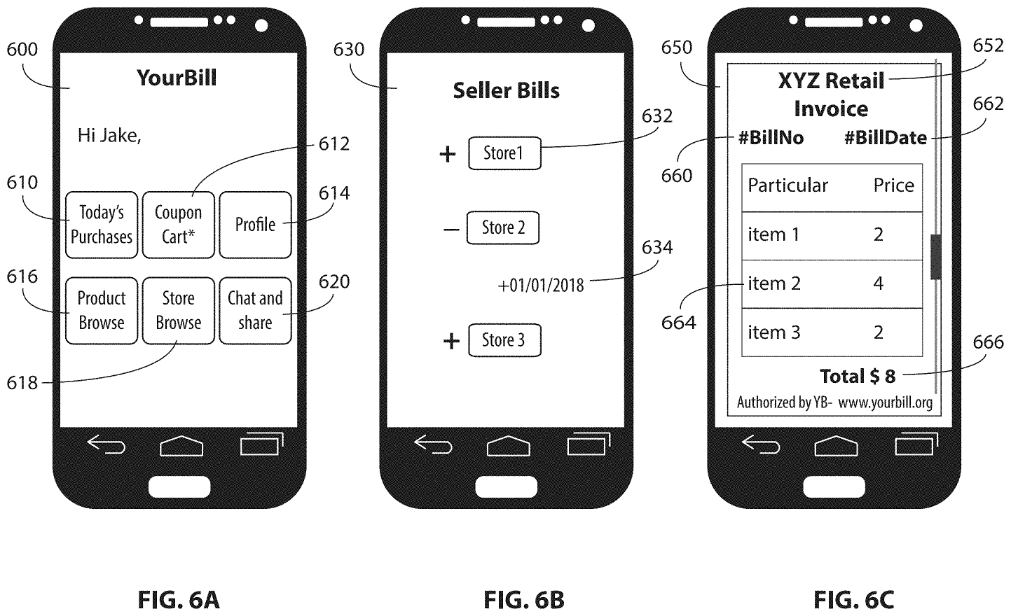

As explained above, the customer uses the mobile application through a smartphone or other mobile devices. The application will provide the customer a variety of options in addition to viewing bills and receipts from previous transactions with registered sellers. The application thus may provide the customer the ability to track daily expenses, browse products, chat and share bills, allow income tax filing, and facilitating the return of products. FIG. 6A shows an example consumer mobile device showing a customer interface 600 generated by the application. The interface 600 includes various buttons to activate different application features. The interface 600 includes a today's purchases button 610, a coupon cart button 612, a profile button 614, a store browse button 616, and a chat and share button 618.

The today's purchases button 610 will allow the receipts of all purchases and transactions made to be displayed. The profile button 614 allows the customer to view and modify their profile. Such modifications are updated in the main database 222 in FIG. 2.

The application includes an income tax return filing feature where the user can run reports on their purchases, including year-end tax-related reports.

The application assists in hassle free and fast return of products. Through the application, the user can sort receipts by type of item purchased, store/location, date, cost, etc. The application provides an improved method for returning purchased items because the transaction receipt for a specific item is always readily available/accessible. [FIG. 6B shows a bills listing user interface 630 generated by the application on the customer mobile device. The bills listing user interface 630 includes a list of bills/receipts received from different sellers 632. Each heading may be expanded to show an addition details field 634 that shows information such as the amount, the date of purchase, and the items purchased.

Individual receipts may also be displayed by the user. FIG. 6C shows an interface 650 that allows a customer to show an image 652 of a receipt received from a transaction. The receipt image 652 includes a bill number 660, a billing date 662, a list of items purchased 664 and a total price 666. Thus, a customer may be provided with detail for any receipt of any transaction with a seller registered with the transaction system 100.

The application allows receipt sharing between users via a “Shared Bill” section within the application. Receipts may be shared between users via E-mail or messaging applications (e.g., WhatsApp) in PDF format. Receipts shared by this method can also be sent to non-registered users as a PDF or other formatted attachment.

The application allows comparative pricing through selecting the product browse button 618. Price comparisons with data from multiple sellers/vendors are provided to registered customers. By selecting the button 618, the customer can search for products and price comparison data may be displayed from participating sellers that carry the product.

Every registered merchant is provided an area for showcasing their offers and available products. The customer can browse their favorite shops from the mobile device without actually visiting the store via the store browse button 618 in FIG. 6A. The user can set a retailer as a “favorite” so that notifications can be presented when the store publishes/offers new promotions or notices.

Users can chat with other users within their group by activating the chat and share button 620. The application allows users to create a group (i.e., a “circle”). Users within a group can share a common list of items that can be modified based on purchasing activity. The most common scenario for group creation is members of a family.

Another feature may be a coupon cart interface that is activated by selecting the coupon cart button 614 in FIG. 6. The coupon cart interface may include promotions and or free coupons provided by registered sellers. Such promotions may be generated by the process detailed above in relation to FIG. 5. When the customer makes the next purchase at the seller offering the promotion, the coupon may be redeemed and reflected in the purchase.

Online purchases from e-commerce sellers may also added into the system 100 from participating e-commerce sellers. The purchases are stored in the respective databases for the sellers and the customers. The application may include an AI chat module for customer support based on frequently asked customer questions.

Based on analyses the transaction system 100 may assist product vendors find new markets and customer preferences. Analyses may be done based on sales data from the sellers that are stored in the database 222 and 230.

For example, if a seller is planning to create a separate sales area to sell products exclusively for new born babies/small children, (e.g., baby powder, baby lotions, strollers, etc.) the seller needs to attract customers who want and/or need such items. Thus, a seller may wish to send a promotion to those customers with a history of purchasing the same or similar items.

The transaction server 110 may run a unique algorithm for analysis of sales data. The algorithm's purpose is to determine future trends in the market based on the analysis of sales/purchasing data. This enables recognition of customers' future needs and allows for pertinent recommendations (via promotions and coupons) to be generated and offered to the customer/user.

The algorithm is based on numerous criteria, including the following: a) frequency of purchase; b) frequency of specific brand purchases; c) price of purchases; d) seasonal purchases; e) related items purchased; f) location of where purchases occurred; and g) age-based purchases (that is, correlation of age of user to items purchased).

A combination of algorithms and libraries may be employed for obtaining results for different purchasing patterns. For predictive analytics, a machine learning library such as the open-source tool Apache Mahout may be used in conjunction with Apache Hadoop. This machine-learning library includes large-scale versions of the clustering, classification, collaborative filtering, and other data-mining algorithms that can support a large-scale predictive analytics model.

For frequent pattern mining, association mining, correlation mining, and association rule learning, the Apriori algorithm may be used. This algorithm is designed to operate on databases containing transactions. Statistical analysis may be used for purchase patterns such as seasonal purchases and related items purchased. Descriptive statistics tools may used for this purpose.

The customer application thus allows digitalizing the process of billing or generating invoices for any transaction at a store by keeping the invoices within a smartphone application (Android/iOS/Windows) for every customer. This application can avoid use of paper invoices and make them available directly in the mobile application.

The system 100 provides a convenient smart phone/electronic device application for shoppers to conveniently retain both printed and electronic transaction receipts. Additionally, the application analyses the user's purchasing and shopping history so that to offer customized promotions (which become coupons if the promotion is accepted) can be offered to the user.

Reporting capabilities based on receipts and purchasing data are available to the user and the retailer for various purposes. Users can also search for receipts based on specific search criteria.

By providing an application with which the consumer/user can save both paper and electronic receipts together in one location, the invention resolves the dilemma of storage, access/retrieval, and transaction-based data analysis. The application also provides the retailer with a means by which promotions/coupons are delivered directly to a consumer/user to facilitate direct customer engagement, reputation building, and revenue enhancement.

The application offers customers hassle free billing at a store. The application allows ease of keeping bills online in an application on the customer mobile device. The application allows ease of exchange of products. The application allows finding a retail store with promotions/offers available. The application allows the formation of a chat circle to form group on purchases and share bills directly with friends and family. The application includes a coupon cart facility to access coupons on next purchase at respective store. The application allows the customer to purchase history-based reminders. The application assists in Income Tax Filing to get tax benefits. The application helps consumers to keep the online retail market bills.

Further the system may be a complete retail solution between a seller and customer. The system 100 allows sellers to monitor sales through the dashboard. The system 100 allows sellers to provide promotion of products/stores instantly through the dashboard. Further, the dashboard may provide sale details for location, seasonal, time at multiple stores and estimate and forecast future sales. The system 100 also helps in finding new customers through application based promotions.

The operator of the transaction system 100 will be able to generate sales leads in the current market. Merchant commissions may be made available for attracting new customers to use the transaction system 100 using the transaction system 100. Further, revenue can be earned on advertisements made in the interfaces presented to the customer in the application on the customer device.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A system to recording a receipt of a transaction, the system comprising:
a point of sale device at a seller location, accepting a sales data input indicating a purchase by a customer;
a transceiver coupled to the point of sale terminal, the transceiver transmitting the sales input data;
a transaction server configured to receive the sales input data, the transaction server generating a receipt of a sale based on the sales input data;
a transceiver paired with a mobile device, the transceiver sending the receipt to the mobile device for storage.

2. The system of claim 1, further comprising a customer interface generator that generates a customer interface on the mobile device, the customer interface including a display of the generated receipt of the purchase from the seller location.

3. The system of claim 2, wherein the receipt is stored on the mobile device.

4. The system of claim 1, wherein data is provided for the receipt to allow classification of the receipt on the mobile device.

5. The system of claim 1, wherein a seller interface is generated, the seller interface displaying sales at the seller location including the sale.

6. The system of claim 4, wherein the seller interface compiles the sales and produces a chart of sales of different products.

7. The system of claim 1, further comprising a seller administration module coupled to a database, and wherein the seller administration module records the sale in a sales database associated with the seller.

8. The system of claim 7, further comprising a database storing the receipt, identification data associated with at least one registered seller and identification data associated with at least one customer.

9. The system of claim 8, further comprising a analytics module coupled to the sales database associated with the seller and the database, the analytics module operable to generate a promotion for the seller to target at least one customer.
